(19) United States
(12) Patent Application Publication
(10) Pub. No.: US 2024/0407010 A1
(43) Pub. Date: Dec. 5, 2024

(54) METHODS AND DEVICES FOR SUBBAND FULL DUPLEX RANDOM ACCESS

(71) Applicant: ZTE Corporation, Shenzhen (CN)

(72) Inventors: Wei GOU, Shenzhen (CN); Xianghui HAN, Shenzhen (CN); Junfeng ZHANG, Shenzhen (CN); Xingguang WEI, Shenzhen (CN); Xing LIU, Shenzhen (CN)

(73) Assignee: ZTE Corporation, Shenzhen (CN)

(21) Appl. No.: 18/799,140

(22) Filed: Aug. 9, 2024

Related U.S. Application Data
(63) Continuation of application No. PCT/CN2022/107153, filed on Jul. 21, 2022.

(51) Int. Cl. H04W 74/0833; H04L 5/14; H04W 72/0453

(52) U.S. Cl. CPC H04W 74/0833; H04L 5/14; H04W 72/0453

(57) ABSTRACT

The present disclosure describes methods, system, and devices for configuring and transmitting a physical random access channel (PRACH) transmission, particularly in a random access channel occasion (RO) for a uplink (UL) subband. A method includes performing, by a user equipment (UE), a PRACH transmission to a base station by: obtaining, by the UE, a RO configuration for a RO; determining, by the UE, whether the RO is valid for a UL subband based on a set of pre-defined rules, wherein the UL subband comprises at least one downlink (DL) symbol or at least one flexible symbol and occupies a part of frequency domain resources of the at least one DL symbol or at least one flexible symbol; and in response to the determining that the RO is valid, transmitting, by the UE, the PRACH transmission in the RO to the base station.

### TECHNICAL FIELD

The present disclosure is directed generally to wireless communications. Particularly, the present disclosure relates to methods and devices for subband full duplex (SBFD) random access.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some existing wireless communication schemes, an uplink (UL) symbol or slot may be configured/scheduled to transmit data or control information from a user equipment to a base station; and a downlink (DL) symbol or slot may be configured/scheduled to transmit data or control information from the base station to the UE. In some existing schemes, UL symbols/slots are fewer and/or discontinuous in comparison to DL symbols/slots, resulting relatively poor performance in term of the timeliness and/or edge coverage of UL transmission, which may be due to no more consecutive UL symbols/slots.

The present disclosure describes various embodiments of configuration/utilization of a UL subband for a subband full duplex (SBFD) random access, addressing at least one of the issues/problems discussed above, improving performance of the wireless communication, particularly the performance of uplink transmission of data/control information.

### SUMMARY

This document relates to methods, systems, and devices for wireless communication, and more specifically, for configuring and transmitting a physical random access channel (PRACH) transmission, particularly in a random access channel occasion (RO) for a UL subband. The various embodiments in the present disclosure may increase the resource utilization efficiency and boost latency performance of the wireless communication.

In one embodiment, the present disclosure describes a method for wireless communication. The method includes performing, by a user equipment (UE), a physical random access channel (PRACH) transmission to a base station by: obtaining, by the UE, a random access channel occasion (RO) configuration for a RO; determining, by the UE, whether the RO is valid for a uplink (UL) subband based on a set of pre-defined rules, wherein the UL subband comprises at least one downlink (DL) symbol or at least one flexible symbol and occupies a part of frequency domain resources of the at least one DL symbol or at least one flexible symbol; and in response to the determining that the RO is valid, transmitting, by the UE, the PRACH transmission in the RO to the base station.

In one embodiment, the present disclosure describes a method for wireless communication. The method includes receiving, by a base station, a physical random access channel (PRACH) transmission from a user equipment (UE) by: configuring, by the base station, a random access channel occasion (RO) configuration for the UE; determining, by the base station, whether the RO is valid for a UL subband based on a set of pre-defined rules, wherein the UL subband comprises at least one downlink (DL) symbol or at least one flexible symbol and occupies a part of frequency domain resources of the at least one DL symbol or at least one flexible symbol; and in response to the determining that the RO is valid, receiving, by the base station, the PRACH transmission in the RO from the UE.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows one exemplary configuration pattern of an uplink (UL) subband in the present disclosure.

FIG. 1C shows another exemplary configuration pattern of a UL subband in the present disclosure.

FIG. 1D shows another exemplary configuration pattern of a UL subband in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of an exemplary embodiment for wireless communication.

FIG. 6 shows a schematic diagram of another exemplary embodiment for wireless communication.

FIG. 7 shows a schematic diagram of another exemplary embodiment for wireless communication.

FIG. 8A shows a schematic diagram of a configuration diagram of a physical random access channel (PRACH) occasion in a UL subband in the present disclosure.

FIG. 8B shows a schematic diagram of another configuration diagram of a PRACH occasion in a UL subband in the present disclosure.

FIG. 8C shows a schematic diagram of another configuration diagram of a PRACH occasion in a UL subband in the present disclosure.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring and transmitting a physical random access channel (PRACH) transmission, particularly in a random access channel occasion (RO) for a UL subband.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some existing wireless communication schemes, a uplink (UL) symbol or slot may be configured/scheduled to transmit data or control information from a user equipment to a base station; and a downlink (DL) symbol or slot may be configured/scheduled to transmit data or control information from the base station to the UE. In some existing schemes, UL symbols/slots are fewer and/or discontinuous in comparison to DL symbols/slots, resulting relatively poor performance in term of the timeliness and/or edge coverage of UL transmission, which may be due to no more consecutive UL symbols/slots.

For a non-limiting example, for a time division duplex (TDD) carrier, a DL symbol (or slot) and a UL symbol (or slot) are time-divisionally configured. Further, in some implementations, DL symbols/slots are configured more than UL symbols/slots.

In the present disclosure, the description of various embodiments/implementations may focus on the level of slots (or the level of symbols in some other various embodiments/implementations), which is not a limitation to the embodiment(s)/implementation(s) and the described embodiments/implementations may be applicable to both the level of slots and the level of symbols.

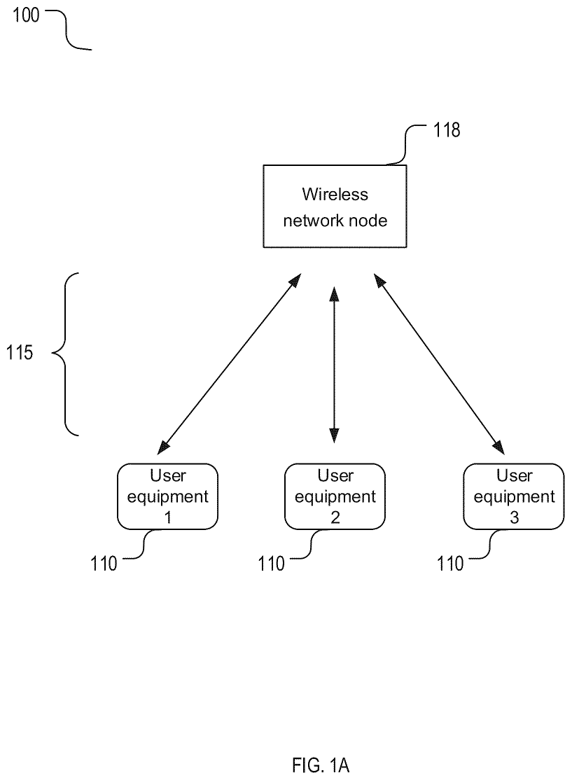

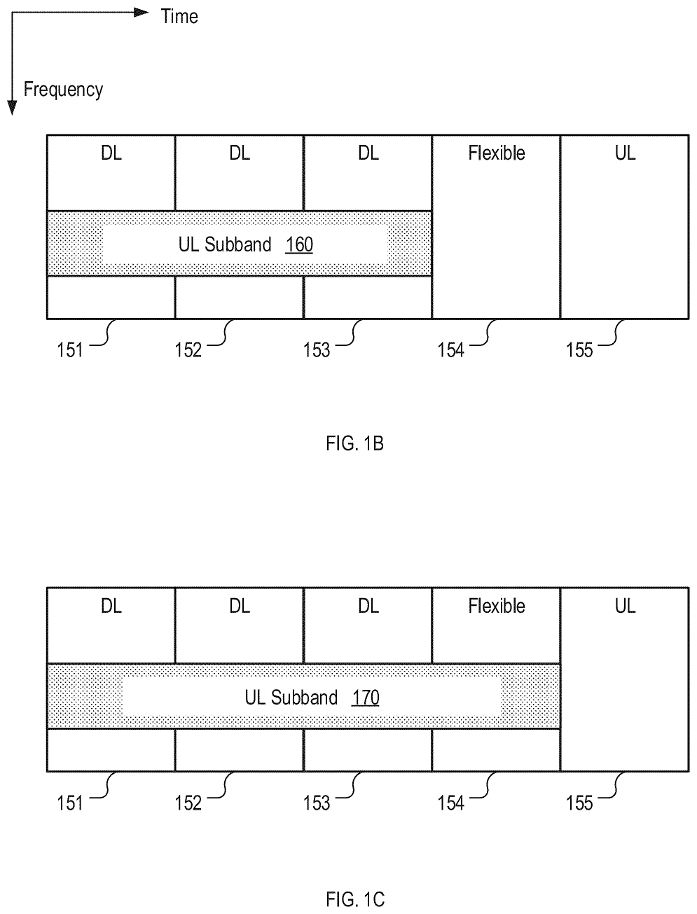

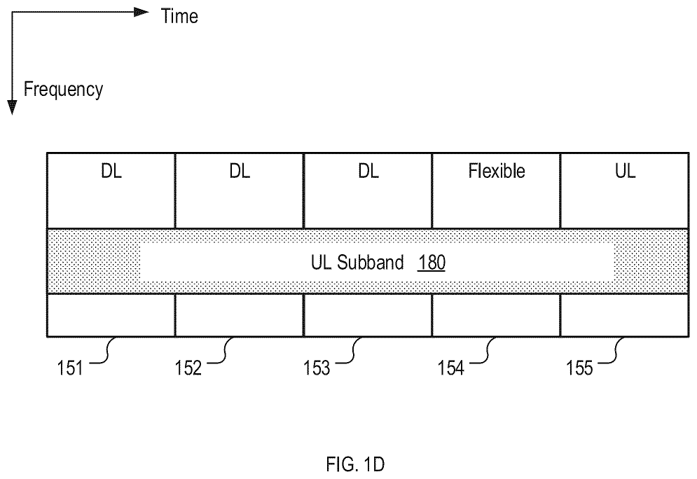

For a non-limiting example, referring to FIG. 1B, a typical symbol/slot structure is DDDSU (151, 152, 153, 154, and 155). Here, D represents a DL symbol/slot, U represents a UL symbol/slot, and S represents a flexible symbol/slot, which contains DL symbols and UL symbols. Obviously, UL slots are fewer and discontinuous, and these characteristics affect the performance of UL transmission. For example, due to no more consecutive or available UL slots, a large data volume of UL may not be supported, and/or more importantly, a timeliness and edge coverage of UL transmission may be relatively poor.

In some implementations, a full-duplex technology based on the UL subband may be implemented as subband full duplex (SBFD), wherein the configuration patterns of the UL subband may have the various types.

FIG. 1B shows one type of the configuration pattern of the UL subband, wherein a UL subband 160 is configured only in DL symbols/slots. In some implementations, the UL subbands may be configured in some or all DL symbols/slots.

FIG. 1C shows another type of the configuration pattern of the UL subband, wherein a UL subband 170 is configured in DL symbols/slots and flexible symbols/slots. In some implementations, the UL subbands may be configured in some or all of the DL symbols/slots and some or all of the flexible symbols/slots.

FIG. 1D shows another type of the configuration pattern of the UL subband, wherein a UL subband 180 is configured in DL symbols/slots, flexible symbols/slots and UL symbols/slots. In some implementations, the UL subbands may be configured in some or all of the DL symbols/slots, some or all of the flexible symbols/slots, and some or all of the UL symbols/slots.

In some implementations, a UL subband may be configured to contain at least one DL symbol/slot.

In various embodiments, a UL subband may provide continuous UL symbols/slots, which is beneficial to expand UL resources, to reduce the delay of UL transmission, for example, by reducing the time waiting for UL opportunities, and/or to improve uplink coverage. The present disclosure describes various embodiments for enhancing the random access procedure based on the UL subband, thus improving the performance of random access in terms of capacity, delay and coverage.

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

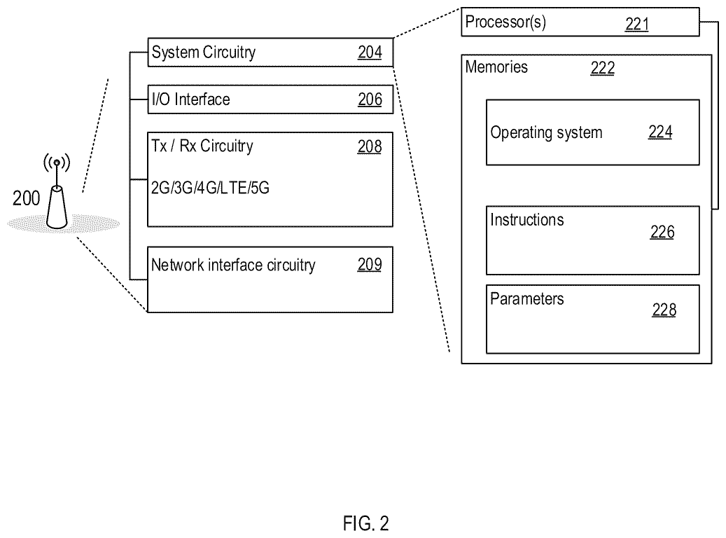

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

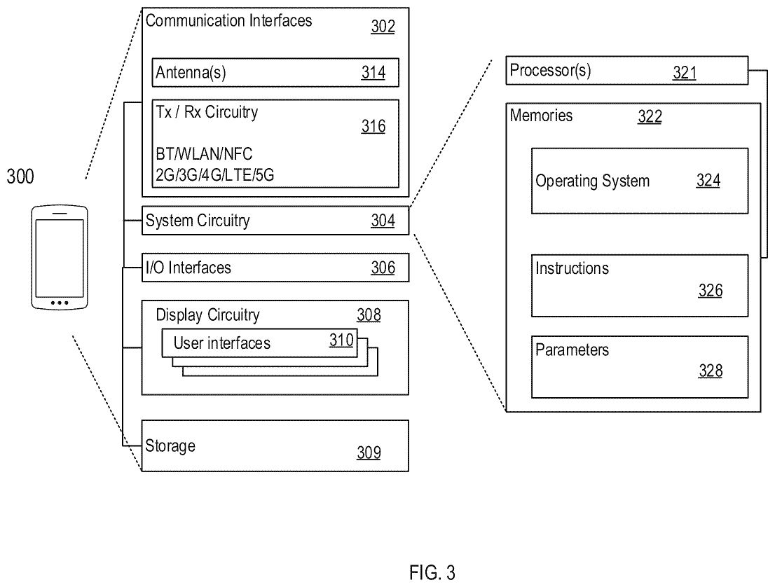

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for configuring and transmitting a physical random access channel (PRACH) transmission, particularly in a random access channel occasion (RO) for a UL subband, which may be implemented, partly or totally, on the network base station and/or the user equipment described above in FIGS. 2-3.

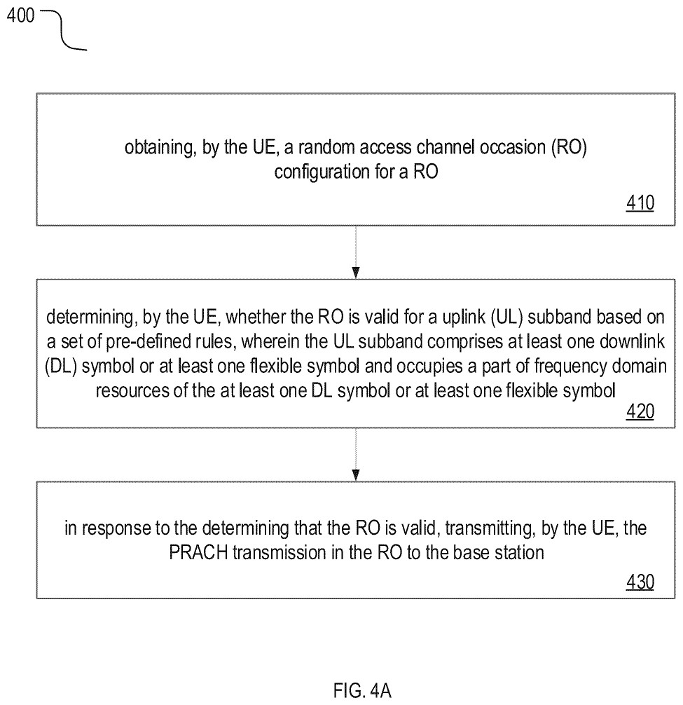

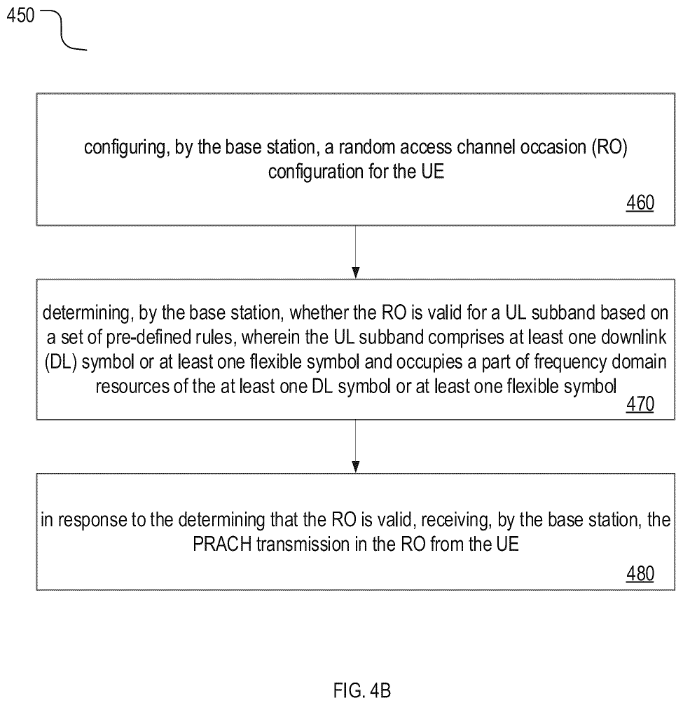

Referring to FIG. 4A, the present disclosure describes various embodiments of a method 400 for wireless communication including performing, by a user equipment (UE), a physical random access channel (PRACH) transmission to a base station. The method may include a portion or all of the following steps: step 410, obtaining, by the UE, a random access channel occasion (RO) configuration for a RO; step 420, determining, by the UE, whether the RO is valid for a uplink (UL) subband based on a set of pre-defined rules, wherein the UL subband comprises at least one downlink (DL) symbol or at least one flexible symbol and occupies a part of frequency domain resources of the at least one DL symbol or at least one flexible symbol; and/or step 430, in response to the determining that the RO is valid, transmitting, by the UE, the PRACH transmission in the RO to the base station.

Referring to FIG. 4B, the present disclosure describes various embodiments of a method 450 for wireless communication including receiving, by a base station, a physical random access channel (PRACH) transmission from a user equipment (UE). The method may include a portion or all of the following steps: step 460, configuring, by the base station, a random access channel occasion (RO) configuration for the UE; step 470, determining, by the base station, whether the RO is valid for a UL subband based on a set of pre-defined rules, wherein the UL subband comprises at least one downlink (DL) symbol or at least one flexible symbol and occupies a part of frequency domain resources of the at least one DL symbol or at least one flexible symbol; and/or step 480, in response to the determining that the RO is valid, receiving, by the base station, the PRACH transmission in the RO from the UE.

In some implementations, in addition to a portion, an entire, or any combination of the described implementation(s)/embodiment(s), the set of pre-defined rules comprises that the UL subband is configured for the UE and the UE is provided with a specific information element (IE); and/or the set of pre-defined rules further comprises at least one of the following: that the RO is in the UL subband; that the RO starts at least T symbols after a last pure downlink symbol, wherein T is an integer; that the RO precedes a specific symbol in a PRACH slot and the RO ends at least T symbols before a first specific symbol; that the RO is later than a specific symbol in a PRACH slot and the RO starts at least T symbols after a last specific symbol; or that the RO starts at least T symbols after a last downlink symbol used for downlink transmission for the UE.

In some implementations, in addition to a portion, an entire, or any combination of the described implementation(s)/embodiment(s), in response to the set of pre-defined rules being satisfied, the UE determines that the RO is valid.

In some implementations, in addition to a portion, an entire, or any combination of the described implementation(s)/embodiment(s), in response to the set of pre-defined rules being satisfied, the base station determines that the RO is valid.

In some implementations, in addition to a portion, an entire, or any combination of the described implementation(s)/embodiment(s), the specific IE comprises an IE of tdd-UL-DL-ConfigurationCommon comprised in a radio resource control (RRC) signaling.

In some implementations, in addition to a portion, an entire, or any combination of the described implementation(s)/embodiment(s), that the RO is in the UL subband comprises at least one of the following: that all time domain resource of the RO is within a time domain resource of the UL subband, and all random access resource in a frequency domain of the RO is within a frequency domain resource of the UL subband; that all time domain resource of the RO is within the time domain resource of the UL subband, and a portion of the random access resource in the frequency domain of the RO is within the frequency domain resource of the UL subband; that a portion of the time domain resource of the RO is within the time domain resource of the UL subband, and all random access resource in the frequency domain of the RO is within the frequency domain resource of the UL subband; or that a portion of the time domain resource of the RO is within the time domain resource of the UL subband, and a portion of the random access resource in the frequency domain of the RO is within the frequency domain resource of the UL subband.

In some implementations, in addition to a portion, an entire, or any combination of the described implementation(s)/embodiment(s), the specific symbol comprises an end or a start synchronization signal (SS)/physical broadcast channel (PBCH) block symbol.

In some implementations, in addition to a portion, an entire, or any combination of the described implementation(s)/embodiment(s), a pure downlink symbol comprises a downlink symbol that is not configured with the UL subband.

In some implementations, in addition to a portion, an entire, or any combination of the described implementation(s)/embodiment(s), a value of the T is associated a subcarrier spacing (SCS) corresponding to the RO; and/or a minimum value of the Tis 0.

In some implementations, in addition to a portion, an entire, or any combination of the described implementation(s)/embodiment(s), the set of pre-defined rules comprises that the UE is provided with a specific information element (IE) and the UE is instructed to perform the PRACH transmission in the RO; and/or the set of pre-defined rules further comprises at least one of the following: that the RO comprises one or more downlink symbol, or that an interval between the RO and a specific symbol is smaller than a required interval threshold.

In some implementations, in addition to a portion, an entire, or any combination of the described implementation(s)/embodiment(s), the set of pre-defined rules further comprises at least one of the following: that the RO spans the UL subband and an uplink symbol in the time domain, that the RO spans the UL subband and a flexible symbol in the time domain, that the flexible symbol is not dynamically indicated for a downlink transmission, that a timing advance (TA) of the uplink symbol and a TA of the UL subband are aligned, that a timing advance (TA) of the flexible symbol and a TA of the UL subband are aligned, that a timing advance offset between the symbols of the UL subband and the UL symbols is predefined as 0 or configured as 0 by the base station, that a timing advance offset between the symbols of the UL subband and the flexible symbols is predefined as 0 or configured as 0 by the base station, that the symbols of the UL subband and the UL symbols are continuous in the time domain, that the symbols of the UL subband and the flexible symbols are continuous in the time domain, or that the base station informs the UE that the RO is valid.

In some implementations, in addition to a portion, an entire, or any combination of the described implementation(s)/embodiment(s), the PRACH transmission is transmitted based on parameters corresponding to the RO.

In some implementations, in addition to a portion, an entire, or any combination of the described implementation(s)/embodiment(s), the UE is configured with an UL subband; the RO is configured in the UL subband in at least one downlink symbols; and/or in response to transmitting, by the UE, the PRACH transmission in the RO within the UL subband: the UE is determined as a UE having UL subband capability by the base station, and at least one of the following: in response to the UE accessing a network, uplink transmission is scheduled in the UL subband, a physical uplink shared channel (PUSCH) associated with the PRACH transmission is scheduled in the UL subband, a physical uplink control channel (PUCCH) associated with the PRACH transmission is scheduled in the UL subband, a hybrid automatic repeat request acknowledgement (HARQ-ACK) physical uplink control channel (PUCCH) associated with the PRACH transmission and corresponding to a physical downlink shared channel (PDSCH) reception with an UE contention resolution identity is scheduled in the UL subband, or in response to a second PRACH transmission from a second RO being scheduled in the UL subband, the UE directly performs the second PRACH transmission without determining an validity of the second RO.

In some implementations, in addition to a portion, an entire, or any combination of the described implementation(s)/embodiment(s), the UE is configured with an UL subband; the RO is configured in the UL subband in at least one downlink symbols; and in response to receiving, by the base station, the PRACH transmission in the RO within the UL subband: the base station determines the UE as a UE having UL subband capability, and at least one of the following: in response to receiving the UE's access to a network, the base station configures/schedules uplink transmission in the UL subband, the base station configures/schedules a physical uplink shared channel (PUSCH) associated with the PRACH transmission in the UL subband, the base station configures/schedules a physical uplink control channel (PUCCH) associated with the PRACH transmission in the UL subband, the base station configures/schedules a hybrid automatic repeat request acknowledgement (HARQ-ACK) physical uplink control channel (PUCCH) associated with the PRACH transmission and corresponding to a physical downlink shared channel (PDSCH) reception with an UE contention resolution identity in the UL subband, or the base station configures/schedules a second PRACH transmission from a second RO for the UE in the UL subband, so that the UE directly performs the second PRACH transmission without determining an validity of the second RO.

In some implementations, in addition to a portion, an entire, or any combination of the described implementation(s)/embodiment(s), the UE is not configured with the UL subband and the base station is aware of existence of the UL subband; and in response to the UE being scheduled to perform a second PRACH transmission from a second RO in a downlink symbol, the UE performs the second PRACH transmission from the second RO without determining an validity of the second RO, or in response to the UE being scheduled with an uplink transmission associated with the PRACH transmission from the downlink symbol, the UE performs the uplink transmission.

In some implementations, in addition to a portion, an entire, or any combination of the described implementation(s)/embodiment(s), the base station is aware of existence of the UL subband that is not configured to the UE; and the base station schedules to perform a second PRACH transmission from a second RO in a downlink symbol, so that the UE performs the second PRACH transmission from the second RO without determining an validity of the second RO, or the base station schedules an uplink transmission associated with the PRACH transmission from the downlink symbol, so that the UE performs the uplink transmission.

In some implementations, in addition to a portion, an entire, or any combination of the described implementation(s)/embodiment(s), the uplink transmission comprising at least one of the following: a physical uplink shared channel (PUSCH), or a physical uplink control channel (PUCCH).

In some implementations, in addition to a portion, an entire, or any combination of the described implementation(s)/embodiment(s), the RO configuration comprises a first parameter and a second parameter in the frequency domain, wherein: the first parameter indicates an offset of a starting resource block (RB) of the RO relative to a starting RB of an UL subband, and/or the second parameter indicates a number of RBs in the RO.

In some implementations, in addition to a portion, an entire, or any combination of the described implementation(s)/embodiment(s), the UL subband is configured to be overlapping and beyond an initial UL bandwidth part (BWP) in the frequency domain; the PRACH transmission is performed in frequency domain resources from the UL subband being overlapping the initial UL BWP; and/or the PRACH transmission for a purpose other than an initial random access is performed in frequency domain resources from the UL subband beyond the initial UL BWP.

In some implementations, in addition to a portion, an entire, or any combination of the described implementation(s)/embodiment(s), the UL subband is configured to be overlapping and within an initial UL BWP in the frequency domain; and/or the PRACH transmission is performed in any frequency domain resource from the UL subband within the initial UL BWP.

In some implementations, in addition to a portion, an entire, or any combination of the described implementation(s)/embodiment(s), in response to frequency domain resources of the UL subband not being configured, the frequency domain resources of the UL subband is same as frequency domain resources of an initial UL BWP.

In some implementations, in addition to a portion, an entire, or any combination of the described implementation(s)/embodiment(s), in response to frequency domain resources of the UL subband not being configured and there being no activated UL BWP, the frequency domain resources of the UL subband is same as frequency domain resources of an initial UL BWP.

In some implementations, in addition to a portion, an entire, or any combination of the described implementation(s)/embodiment(s), in response to frequency domain resources of the UL subband not being configured and there being an activated UL BWP, the frequency domain resources of the UL subband is same as frequency domain resources of the activated UL BWP.

The present disclosure describes some specific non-limiting embodiments for configuring and transmitting a physical random access channel (PRACH) transmission, particularly in a random access channel occasion (RO) for a UL subband.

### Embodiment 1

The present disclosure describes how a UE (or a base station) determines a validity of a RO.

In some implementations, a PRACH occasion (or RACH Occasion) (RO) is a resource for the UE to perform PRACH transmission. Multiple ROs may be configured in the time domain. Within each RO in the time domain, one or more random access resources may be configured in the frequency domain. These random access resources may be continuous or discrete in the frequency domain. In some implementations, the base station and the UE may consider that the RO is invalid if an RO is configured to contain DL symbols, because the UE cannot perform UL transmission in the DL symbols. Further, in the slot configured with RO, if the interval between the start of a RO and the DL symbol is not large enough, the RO may also be invalid, considering that it takes a certain time for the UE to perform switching between UL transmission and DL transmission.

The present disclosure describes various implementations for supporting PRACH transmission in the UL subband, wherein a UE with UL subband capability may perform random access procedures in the RO of the UL subband. In some implementations, the UL subband contains at least one or more DL symbol.

The present disclosure describes various methods for determining a validity of the RO based on various rules, respectively. In some non-limiting exemplary method, when the UL subband is configured for the TDD carrier, the base station and the UE may agree to configure the RO based on an existing RO configuration signaling, and/or to determine the validity of the RO based on various rules.

In some implementations, an OFDM symbol may have only a single UL or DL transmission direction, so the validity of a RO is determined only based on some time domain resource information.

In some implementations, frequency domain resource information is further added in order to determine the validity of a RO, since at least UL subbands are configured in DL symbols. That is, part of frequency domain resources of one DL symbol are used for UL transmission, wherein, a DL symbol may have both DL and UL transmission directions when the UL subband is configured in the DL symbol.

For one non-limiting rule (Rule 1), when the UL subband is configured (i.e. for the UE, the UL subband is present, or the UE has UL subband capability), and when the UE is provided with a specific information element (e.g., tdd-UL-DL-ConfigurationCommon), a PRACH occasion in a PRACH slot in a UL subband is determined as valid.

When the base station configures the UL subband (i.e. for the UE, the UL subband is present, or the UE has UL subband capability) and provides the slot configuration parameter (e.g, tdd-UL-DL-ConfigurationCommon) for the UE, and when the base station configures a RO in the UL subband, the base station determines that the RO is valid.

In some implementations, the UL subband is configured in a DL symbol or a DL slot, wherein a DL slot may be a lot in which all symbols are DL symbols. In some implementations, a RO contains one or more random access resources in the frequency domain.

In some implementations, a RO in the UL subband may refer to any one or any combination of the following: the time domain resources of the RO are within the time domain resources of the UL subband, and the frequency domain resources of at least one random access resource in the RO are within the frequency domain of the UL subband; the time domain resources of the RO are within the time domain resources of the UL subband, and the frequency domain resources of all random access resources in the RO are within the frequency domain of the UL subband; part of the time domain resources of the RO are within the time domain resources of the UL subband, and the frequency domain resources of at least one random access resource in the RO are within the frequency domain of the UL subband; or part of the time domain resources of the RO are within the time domain resources of the UL subband, and the frequency domain resources of all random access resources in the RO are within the frequency domain of the UL subband.

For another non-limiting rule, when the UL subband is configured (i.e. for the UE, the UL subband is present, or the UE has UL subband capability), and when the UE is provided with a specific information element (e.g, tdd-UL-DL-ConfigurationCommon), a PRACH occasion in UL subband within a PRACH slot is valid when one or a combination of the following condition is satisfied.

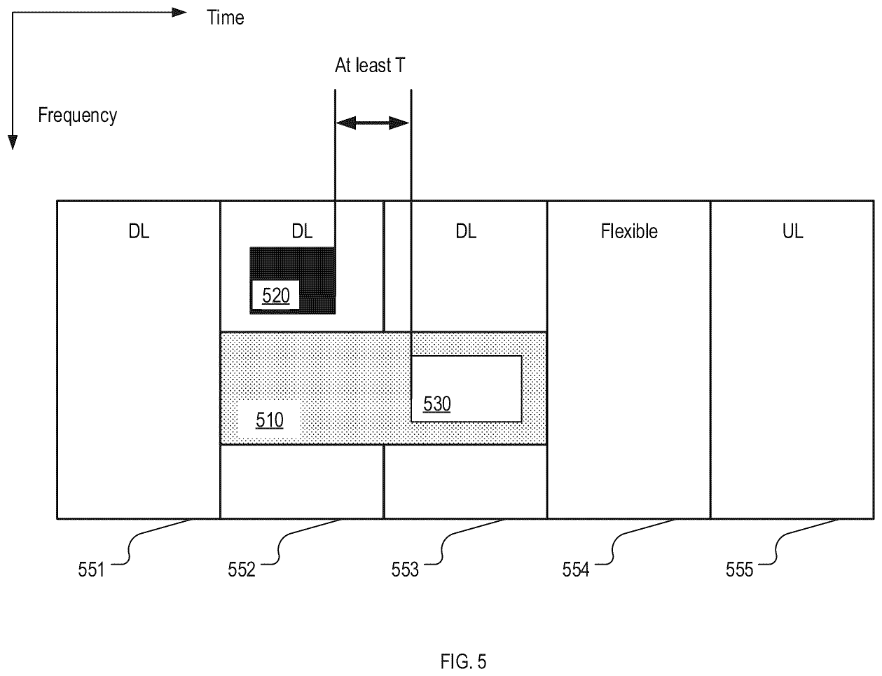

One condition is that the PRACH occasion does not precede a SS/PBCH block in the PRACH slot and starts at least T symbols after a last SS/PBCH block symbol, where the value of T is associated with a subcarrier spacing (SCS) corresponding to the RO resource. T may be a non-negative integer and the minimum value of T may be 0. FIG. 5 shows one example of such condition, wherein a DL symbol (551), a DL symbol (552), a DL symbol (553), a flexible symbol (554), and a UL symbol (555) are configured. A UL subband (510) is configured for the UE in two DL symbols (552 and 553). The start of a RO (530) should satisfy the condition of at least T symbols after the end of a last SSB block symbol (520).

Another condition is that the PRACH occasion does not precede a SS/PBCH block in the PRACH slot and starts at least T symbols after a last pure downlink symbol, where the value of T is associated with the SCS corresponding to the RO resource. T may be a non-negative integer and the minimum value of T may be 0. Here, in the present disclosure, a pure DL symbol may be a DL symbol that is not configured with an UL subband.

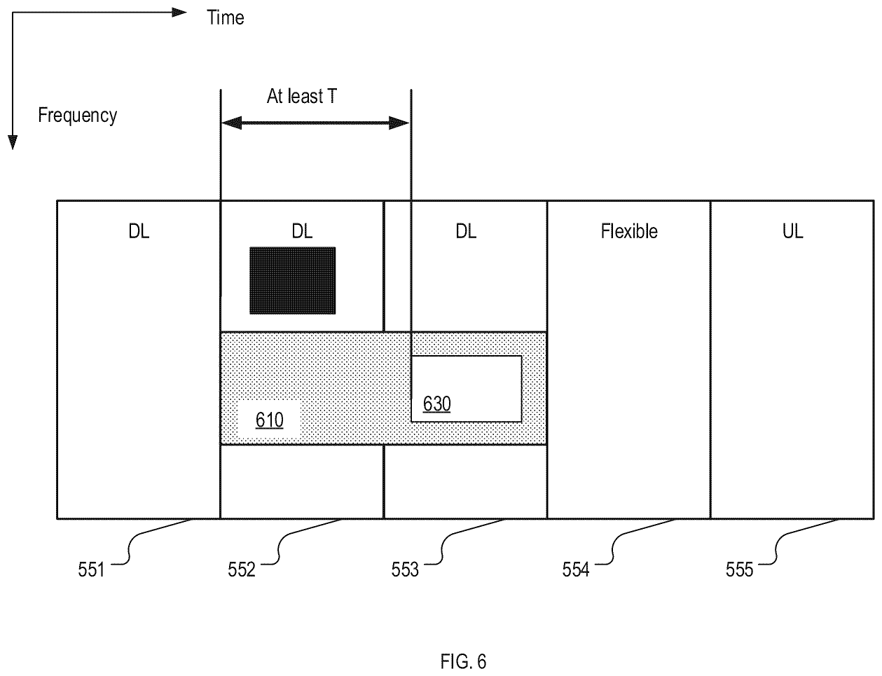

FIG. 6 shows one example of such condition, wherein a DL symbol (551), a DL symbol (552), a DL symbol (553), a flexible symbol (554), and a UL symbol (555) are configured. A UL subband (610) is configured for the UE in two DL symbols (552 and 553). The start of a RO (630) should satisfy a condition of at least T symbols after the end of a pure DL symbol, which, in this example, is the DL symbol (551).

Another condition is that the PRACH occasion precedes a SS/PBCH block in the PRACH slot and ends at least T symbols before a first SS/PBCH block symbol, where the value of T is associated with the SCS corresponding to the RO resource. T may be a non-negative integer and the minimum value of T may be 0.

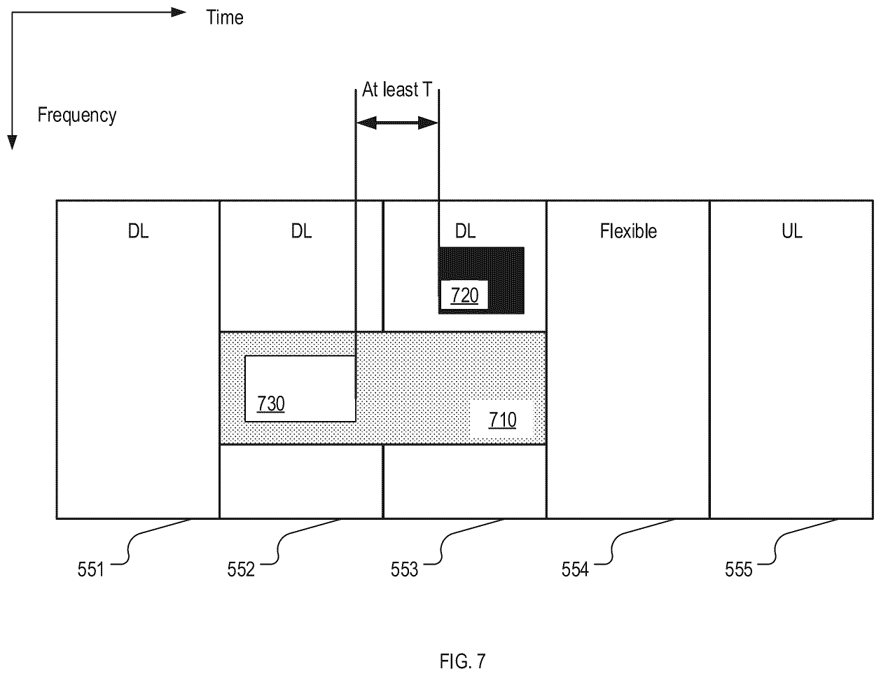

FIG. 7 shows one example of such condition, wherein a DL symbol (551), a DL symbol (552), a DL symbol (553), a flexible symbol (554), and a UL symbol (555) are configured. A UL subband (710) is configured for the UE in two DL symbols (552 and 553). The end of a RO (730) should satisfy the condition of at least T symbols before the start of a first SSB block symbol (720).

Another condition is that the PRACH occasion precedes a SS/PBCH block in the PRACH slot and starts at least T symbols after a last pure downlink symbol, where the value of T is associated with the SCS corresponding to the RO resource. T may be a non-negative integer and the minimum value of T may be 0.

For another non-limiting rule (Rule 2), when the UL subband is configured (i.e. for the UE, the UL subband is present, or the UE has UL subband capability), and when the UE is provided a specific information element (e.g, tdd-UL-DL-ConfigurationCommon), a PRACH occasion in DL symbol within a PRACH slot is valid when it is in UL subband within the DL symbol.

For another non-limiting rule (Rule 3), when the UL subband is configured (i.e. for the UE, the UL subband is present, or the UE has UL subband capability), and when a UE is provided a specific information element (e.g, tdd-UL-DL-ConfigurationCommon), a PRACH occasion in UL subband within a PRACH slot is valid when it does not precede a SS/PBCH block in the PRACH slot and starts at least T symbols after a last pure downlink symbol and at least T symbols after a last SS/PBCH block symbol. The value of T is associated with the SCS corresponding to the RO resource. T may be a non-negative integer and the minimum value of T may be 0.

For another non-limiting rule (Rule 4), when the UL subband is configured (i.e. for the UE, the UL subband is present, or the UE has UL subband capability), and when the UE is provided a specific information element (e.g, tdd-UL-DL-ConfigurationCommon), a PRACH occasion in in UL subband within a PRACH slot is valid when it does not precede a SS/PBCH block in the PRACH slot and starts at least T symbols after a last DL symbol used for downlink transmission of the UE and at least T symbols after a last SS/PBCH block symbol. The value of T is associated with the SCS corresponding to the RO resource. T may be a non-negative integer and the minimum value of T may be 0.

For a non-comprehensive and/or non-conclusive summary, in various embodiments, the UL subband is configured (i.e. for the UE, the UL subband is present, or the UE has UL subband capability), and if a UE is provided a specific information element (e.g, tdd-UL-DL-ConfigurationCommon), a PRACH occasion in DL symbol within a PRACH slot is valid when it satisfies one or more of the following conditions.
1) The RO is in the UL subband.
2) The interval between the start symbol of the RO and the last pure DL symbol in the slot is at least T.
3) The end symbol of the RO precedes the start symbol of the SSB, and the interval between the end symbol of the RO and the start symbol of the SSB is at least T.
4) The start symbol of the RO is later than the end symbol of the SSB, and the interval between the start symbol of the RO and the end symbol of the SSB is at least T.
5) For a UE, the interval between the start symbol of the RO and the last DL symbol used for downlink transmission of the UE in the slot is at least T.

In some implementations, the value of T is associated with the SCS corresponding to the RO resource. T may be a non-negative integer and the minimum value of T may be 0.

In various embodiments/implementations in the present disclosure, the above rules are executed by the base station and the UE separately and/or respectively.

For an RO, when the above conditions described in various embodiments/implementations are not met, the UE considers the RO to be invalid; and/or the base station considered the RO to be invalid.

The present disclosure describes another method for determining a validity of the RO based on various rules. For a UE with UL subband capability, when the UE is not configured with UL subband, but is provided a specific information element (e.g, tdd-UL-DL-ConfigurationCommon), and when the UE is instructed to perform a PRACH transmission in an RO, but the RO contains DL symbol (or the interval between the RO and the SSB does not meet the required interval size for a valid RO), the UE considers the RO to be valid and performs the PRACH transmission in the RO.

In some implementations, since the UE is not configured with the UL subband, the UE cannot identify the UL subband. The base station knows that the UL subband exists and there is an RO in the UL subband, so when the base station schedules or triggers a PRACH transmission in the RO, the UE considers the RO to be valid and performs the PRACH transmission in the RO. In some implementations, the PRACH transmission triggered by the base station may adopt this method. In some implementations, the base station needs to ensure the validity of the RO for the UE with UL subband capability, and the UE does not need to determine the validity of the RO, and the UE only needs to perform PRACH transmission according to the scheduling of the base station.

The present disclosure describes another method for determining a validity of the RO based on various rules, wherein the RO may across UL subbands and non-UL subbands in the time domain.

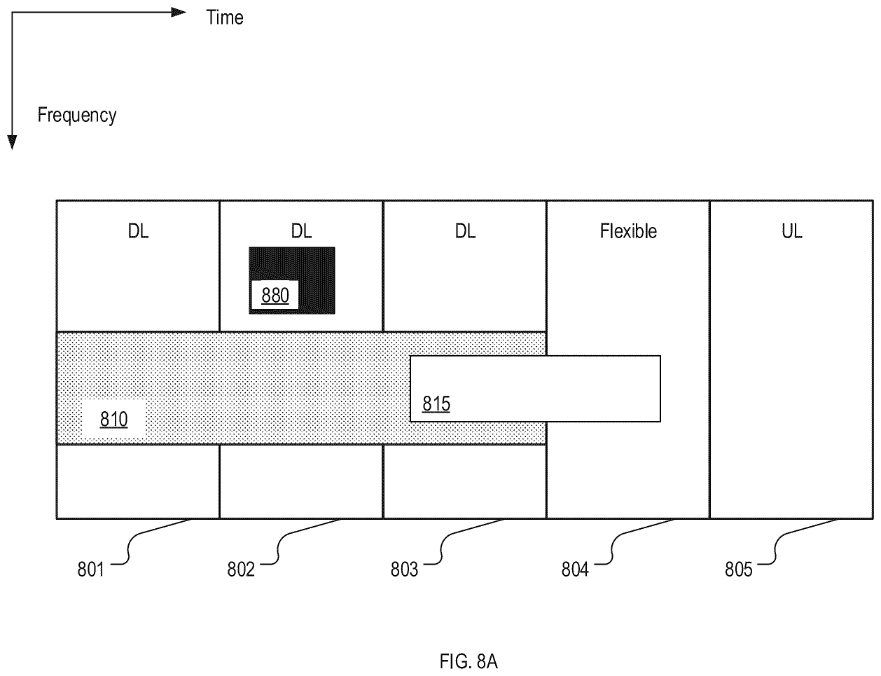

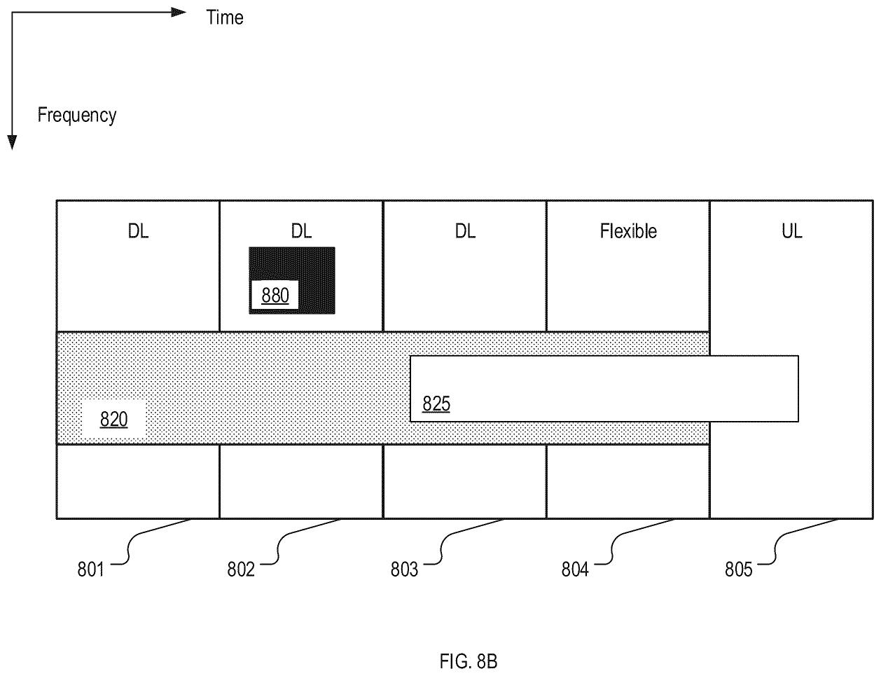

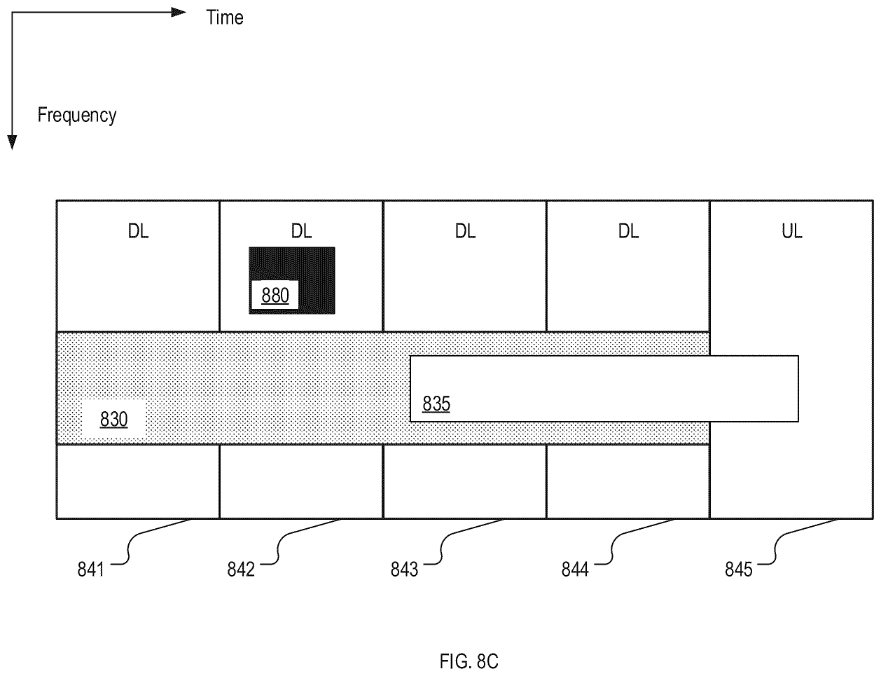

In some implementation, referring to FIG. 8A, a DL symbol (801), a DL symbol (802), a DL symbol (803), a flexible symbol (804), and a UL symbol (805) are configured; and a UL subband (810) contains one or more DL symbols (e.g., 801, 802, and 803). A RO (815) may span the UL subband (810) and one or more F symbol (04). In some implementations, the RO in the F symbol may be the configured UL bandwidth part (BWP). A SSB (880) may be configured.

In some implementation, referring to FIG. 8B, a UL subband (820) may contain one or more DL symbols (e.g., 801, 802, and 803) and one or more F symbols (804). A RO (825) may span the UL subband (820) and one or more UL symbol (e.g., 805). In some implementations, the RO in the UL symbol is the configured UL BWP.

In some implementation, referring to FIG. 8C, a DL symbol (841), a DL symbol (842), a DL symbol (843), a DL symbol (844), and a UL symbol (845) are configured;

and a UL subband (830) may contain one or more DL symbol (e.g., 841, 842, 843, and 844). A RO (835) spans the UL subband (830) and one or more UL symbol (e.g., 845). In some implementations, the RO in the UL symbol is the configured UL BWP.

In the above three non-limiting examples as shown in FIGS. 8A-C, one RO spans the UL subband and symbols not allocated to the UL subband in the time domain. In this case, the RO validity also needs to be determined for UEs with UL subband capability. For this type of RO validity, the following conditions are used to determine. In some implementations, a final validity of RO may need be determined jointly with the any one or any combination of the methods described above.

In some implementations, the base station and UE may determine, either separately or collaboratively, that, when a RO spans UL subband and UL (or F) symbol in the time domain, the RO may be considered as valid RO, wherein the UL subband is not configured in the UL (or F) symbol.

In some implementations, the base station and UE may determine, either separately or collaboratively, that, when a RO spans UL subband and UL (or F) symbol in the time domain, the RO may be considered as invalid RO, wherein the UL subband is not configured in the UL (or F) symbol.

In some implementations, the base station and UE may determine, either separately or collaboratively, that, when a RO spans UL subband and the F symbol in the time domain, the RO may be a valid RO when the F symbol is not dynamically indicated for DL transmission, wherein the UL subband is not configured in the F symbol.

In some implementations, the base station and UE may determine, either separately or collaboratively, that, when a RO spans UL subband and the F symbol in the time domain, the RO may be an invalid RO when the F symbol is dynamically indicated for DL transmission, wherein the UL subband is not configured in the F symbol.

In some implementations, the base station and UE may determine, either separately or collaboratively, that, when a RO spans the UL subband and the UL (or F) symbol in the time domain, the RO may be a valid RO when a timing advance (TA) of the UL (or F) symbol or UL BWP (e.g., the UL BWP are configured in the UL/F symbol) and the TA of the UL subband are aligned. Specifically, the TA alignment includes at least one of the following: that a TA offset between the symbols of the UL subband and the UL (or F) symbols is predefined as 0 or configured as 0 by the base station; or that the symbols of the UL subband and the UL (or F) symbols are continuous in the time domain.

In some implementations, the base station and UE may determine, either separately or collaboratively, that, when a RO spans the UL subband and the UL (or F) symbol in the time domain, the RO may be an invalid RO when a timing advance (TA) of the UL (or F) symbol or UL BWP (e.g., the UL BWP are configured in the UL/F symbol) and the TA of the UL subband are not aligned. Specifically, the TA alignment includes at least one of the following: that a TA offset between the symbols of the UL subband and the UL (or F) symbols is predefined as 0 or configured as 0 by the base station; or that the symbols of the UL subband and the UL (or F) symbols are continuous in the time domain.

In some implementations, serving as a flexible approach, when a RO spans UL subband and UL (or F) symbols in the time domain, the base station informs via signaling that the RO is valid.

In some implementations, serving as a flexible approach, when a RO spans UL subband and UL (or F) symbols in the time domain, the base station informs via signaling that the RO is invalid.

In the above described embodiments/implementations, the conditions for determining the validity of the RO resource may also be applied to the PUSCH and the PUCCH in the UL subband. For example, the above described methods/rules/conditions are applicable to PUSCH or PUCCH. When the UE is scheduled by the base station for a PUSCH transmission or PUCCH transmission in the UL subband, within a slot, the UE may not expect that the PUSCH or PUCCH does not meet the above interval-related conditions; in another word, the UE may expect the PUSCH or PUCCH to meet the above interval condition. For a non-limiting example, for a UE, the interval between the PUSCH or PUCCH and the SSB (or the last pure downlink symbol in the slot, or the last DL symbol of the scheduled downlink data in the slot for the UE) may satisfy the interval T within one slot. Thus, the various above described embodiments/implementations are generally applicable by replacing RO with PUSCH or PUCCH.

In some implementations, for a valid RO determined in the various above described embodiments/implementations, when random access is allowed to be performed in the RO, PRACH transmission is based on parameters related to the RO configuration, for example, SCS and PRACH structure parameters of the RO configuration, which may not be based on parameters configured for this UL subband.

In some implementations, for a valid RO determined in the various above described embodiments/implementations, the SCS of the RO may remain the same as the SCS of the UL subband. Its purpose is that since the RO is located in some DL symbols, when the SCS of the RO is different from the SCS of the DL transmission in these DL symbols, the UL subband may have more interference.

### Embodiment 2

The present disclosure describes how a UE and/or a base station schedule to perform UL transmission in a UL subband. In some implementations, the UE with UL subband capability is identified using the RO within the UL subband. The UL subband is configured in DL symbols.

For one non-limiting example, the UE is configured with the UL subband and the RO is configured in the UL subband in DL symbols.

Regarding base station side operations, when a PRACH transmission is received by the base station in an RO within a UL subband, the base station considers that the UE corresponding to the PRACH transmission is a UE with UL subband capability. When the UE accesses the network, the base station may schedule the UE to perform UL transmission (PUSCH or PUCCH) in the UL subband.

Regarding UE side operations, when a PRACH transmission is transmitted by the UE in an RO within a UL subband, the base station considers that the UE corresponding to the PRACH transmission is a UE with UL subband capability. When the UE accesses the network, the base station may schedule the UE to perform UL transmission (PUSCH or PUCCH) in the UL subband.

In some implementations, the PRACH transmission can be actively initiated by the UE, or can be scheduled/triggered by the base station, such as PDCCH order triggering.

Regarding base station side operation, when a PRACH transmission is received by the base station in an RO within a UL subband, the PUSCH (for example, msg3) associated with the PRACH transmission (or scheduled by the UL grant (or RAR UL grant) scrambled by RA-RNTI) may be scheduled in the UL subband and/or UL symbols.

In some implementations, the UL symbols may be replaced by UL BWPs because UL transmission is performed in UL BWPs within UL symbols. The same processing is supported below.

In some implementations, the UL symbols can be replaced by flexible (F) symbols. The same processing is supported below.

Regarding UE side operations, when a PRACH transmission is transmitted by the UE in an RO within a UL subband, then the PUSCH (for example, msg3) associated with the PRACH transmission (or scheduled by the UL grant (or RAR UL grant) scrambled by RA-RNTI) can be scheduled in the UL subband and/or UL symbols.

In some implementations, the PRACH transmission can be actively initiated by the UE, or can be scheduled/triggered by the base station, such as PDCCH order triggering.

Regarding base station side operations, when a PRACH transmission is received by the base station from the RO in the UL subband, the HARQ-ACK PUCCH associated with the PRACH transmission and corresponding to the PDSCH reception with the UE contention resolution identity can be scheduled in the UL subband and/or UL symbols.

Regarding UE side operations, when a PRACH transmission is transmitted by the UE from the RO in the UL subband, the HARQ-ACK PUCCH associated with the PRACH transmission and corresponding to the PDSCH reception with the UE contention resolution identity can be scheduled in the UL subband and/or UL symbols.

In some implementations, the PRACH transmission can be actively initiated by the UE, or can be scheduled/triggered by the base station, such as PDCCH order triggering.

Regarding base station side operations, the UE with the UL subband capability accessing the network reports the capability to the base station. After the base station obtains the UE with UL subband capability, the base station can schedule or trigger the UE to perform a PRACH transmission from an RO in the UL subband in the DL symbol. When a PRACH transmission scheduled or triggered by the base station is received by the base station from an RO in the UL symbol (including PRACH transmission triggered by PDCCH order), the PUSCH or PUCCH associated with the PRACH transmission can be scheduled in the UL subband and/or UL symbols.

Regarding UE side operations, for a UE with UL subband capability that accesses the network, the UE reports the capability to the base station. The UE can be scheduled or triggered to perform a PRACH transmission from a RO in the UL subband of the DL symbol. When a PRACH transmission scheduled or triggered by the base station is transmitted by the UE from an RO in the UL symbol (including PRACH transmission triggered by PDCCH order), the PUSCH or PUCCH associated with the PRACH transmission can be scheduled in the UL subband and/or UL symbols.

Regarding base station side operation, when the base station schedules/triggers an RO for PRACH transmission in the UL subband (even if the RO does not meet the above interval conditions, that is, the RO is an invalid RO), the base station expects the UE to perform the PRACH transmission in the RO.

Regarding UE side operations, when the UE is scheduled/triggered to perform a PRACH transmission on an RO in the UL subband (but the RO does not meet the above interval condition, that is, the RO is an invalid RO), the UE directly performs the PRACH The transmission is in this RO. That is, if the base station schedules/triggers the UE to perform a PRACH transmission from an RO in the UL subband, the UE directly performs the PRACH transmission from the RO without judging the validity of the RO.

For another non-limiting example, the UL subband is not configured for the UE, but the base station knows that the UL subband exists. The UE may not actively initiate PRACH transmission in the RO in the UL sub-band, and the base station can schedule/trigger a UE to perform PRACH transmission in the RO in the UL sub-band when the UE reports with the UL subband capability.

Regarding base station side operations, the base station can schedule or trigger a UL subband capable UE to perform a PRACH transmission from an RO in the DL symbol. The base station allows scheduling the PUSCH (or scheduled by the UL grant (or RAR UL grant) scrambled by RA-RNTI) or HARQ-ACK PUCCH (corresponding to the PDSCH reception with the UE contention resolution identity) associated with the PRACH transmission to be transmitted from the DL symbols and/or in the UL symbol.

Regarding UE operations, when the UE is scheduled or triggered to perform a PRACH transmission from a RO in the DL symbol, the UE performs the PRACH transmission from the RO (without judging the validity of the RO). Further, when the PUSCH or PUCCH associated with the PRACH transmission is scheduled to be transmitted from the DL symbol, the UE performs the PUSCH or PUCCH transmission according to the scheduling information.

### Embodiment 3

The present disclosure describes how a UE and/or a base station configure a RO in a UL subband. In some implementations, the RO is independently configured as a UL subband by the UE and the base station.

In various embodiments in the present disclosure, a RO may contain time domain resources and frequency domain resources, and the frequency domain resource configuration of the RO may use one or more parameter, including at least one of the following parameters.

One parameter (Parameter 1) may be introduced to describe an offset of the starting RB of PRACH Occasion relative to the starting RB of a UL subband, so that the starting RB of the first random access resource in the frequency domain within a RO is determined. Here, the PRACH occasion indicates that the first random access resource in an RO is in the frequency domain.

Another parameter (Parameter 2) may be introduced to describe a number of random access resources in a RO in the frequency domain. The size of a random access resource in the frequency may can be determined based on the random access sequence length and the SCS of the RO. Multiple random access resources in a RO may be contiguous in the frequency domain.

### Embodiment 4

The present disclosure describes how a UE and/or a base station configure frequency domain resources of a RO in a UL subband, particularly the relationship of the UL subband to an initial UL BWP. The UL subband may contain at least one type of the following: DL symbols, UL symbols, and/or F symbols.

In some implementations, in the frequency domain, the size and position of the UL subband may be configured beyond a size and a position of the initial UL BWP. When the UE wants to perform a PRACH transmission or PUSCH transmission or PUCCH transmission from this UL subband, within the UL subband, the same frequency domain resources as the initial UL BWP may be used (or the whole frequency domain resources of the UL subband may be used). The base station and the UE may agree with or determine that in the frequency domain resources beyond the initial UL BWP, the UE is not allowed to perform a PRACH transmission for initial random access, but can perform a PRACH transmission for other purposes.

In some implementations, in the frequency domain, the size and position of the UL subband may be configured not to exceed a size and a position of the initial UL BWP. When the UE wants to perform a PRACH transmission or PUSCH transmission or PUCCH transmission from the UL subband, the entire frequency domain resources of the UL subband may be used for them.

In some implementations, the base station and the UE may agree with or determine, separately or collaboratively, that, in the frequency domain, when the frequency domain resources of the UL subband are not configured, the frequency domain resources of the UL subband may be the same as the frequency domain resources of the initial UL BWP.

In some implementations, the base station and the UE may agree with or determine, separately or collaboratively, that, in the frequency domain, when the frequency domain resources of the UL subband are not configured and there is no active UL BWP, the frequency domain resources of the UL subband may be the same as the frequency domain resources of the initial UL BWP.

In some implementations, the base station and the UE may agree with or determine, separately or collaboratively, that, in the frequency domain, when the frequency domain resources of the UL subband are not configured and there is an activated UL BWP, the frequency domain resources of the UL subband may be the same as the frequency domain resources of the activated UL BWP.

The various embodiments/implementations described in the present disclosure may enable the associated configuration of the initial UL BWP and the UL subband, making the system more robust.

The present disclosure describes methods, apparatus, and computer-readable medium for wireless communication. The present disclosure addressed the issues with configuring and transmitting a physical random access channel (PRACH) transmission, particularly in a random access channel occasion (RO) for a UL subband. The methods, devices, and computer-readable medium described in the present disclosure may facilitate the performance of wireless communication by configuring and transmitting a RO in a UL subband, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
performing, by a user equipment (UE), a physical random access channel (PRACH) transmission to a base station by:
obtaining, by the UE, a random access channel occasion (RO) configuration for a RO;
determining, by the UE, whether the RO is valid for a uplink (UL) subband based on a set of pre-defined rules, wherein the UL subband is configured in at least one downlink (DL) symbol or at least one flexible symbol and is configured within a part of frequency domain resources of the at least one DL symbol or at least one flexible symbol; and
in response to the determining that the RO is valid, transmitting, by the UE, the PRACH transmission in the RO to the base station.

2. (canceled)

3. The method according to claim 1, wherein:
the set of pre-defined rules comprises that the UL subband is configured for the UE and the UE is provided with a specific information element (IE);
the determining whether the RO is valid comprises: in response to the set of pre-defined rules being satisfied, determining that the RO is valid;
the set of pre-defined rules further comprises at least one of the following:
that the RO is in the UL subband;
that the RO starts at least T symbols after a last pure downlink symbol, wherein T is an integer;
that the RO precedes a specific symbol in a PRACH slot and the RO ends at least T symbols before a first specific symbol;
that the RO is later than a specific symbol in a PRACH slot and the RO starts at least T symbols after a last specific symbol; or
that the RO starts at least T symbols after a last downlink symbol used for downlink transmission for the UE; and
the specific symbol comprises an end or a start synchronization signal (SS)/physical broadcast channel (PBCH) block symbol.

4. (canceled)

5. (canceled)

6. The method according to claim 3, wherein:
the specific IE comprises an IE of tdd-UL-DL-ConfigurationCommon comprised in a radio resource control (RRC) signaling.

7. The method according to claim 3, wherein:
that the RO is in the UL subband comprises at least one of the following:
that all time domain resource of the RO is within a time domain resource of the UL subband, and all random access resource in a frequency domain of the RO is within a frequency domain resource of the UL subband;
that all time domain resource of the RO is within the time domain resource of the UL subband, and a portion of the random access resource in the frequency domain of the RO is within the frequency domain resource of the UL subband;
that a portion of the time domain resource of the RO is within the time domain resource of the UL subband, and all random access resource in the frequency domain of the RO is within the frequency domain resource of the UL subband; or
that a portion of the time domain resource of the RO is within the time domain resource of the UL subband, and a portion of the random access resource in the frequency domain of the RO is within the frequency domain resource of the UL subband.

8. (canceled)

9. (canceled)

10. (canceled)

11. (canceled)

12. The method according to claim 3, wherein:
the set of pre-defined rules further comprises at least one of the following:
that the RO spans the UL subband and an uplink symbol in the time domain,
that the RO spans the UL subband and a flexible symbol in the time domain,
that the flexible symbol is not dynamically indicated for a downlink transmission,
that a timing advance (TA) of the uplink symbol and a TA of the UL subband are same,
that a timing advance (TA) of the flexible symbol and a TA of the UL subband are same,
that a timing advance offset between the symbols of the UL subband and the UL symbols is predefined as 0 or configured as 0 by the base station,
that a timing advance offset between the symbols of the UL subband and the flexible symbols is predefined as 0 or configured as 0 by the base station, or
that the RO starting from a subband full duplex (SBFD) symbol configured with the UL subband and ending in a non-SBFD symbol not configured with the UL subband is determined to be valid based on configuration signaling from the base station, wherein the same frequency resources are used for both the SBFD symbol and non-SBFD symbol of the RO, and the SBFD symbol and the non-SBFD symbol for the RO are continuous in the time domain.

13. (canceled)

14. The method according to claim 1, wherein
the UE is configured with an UL subband;
the RO is configured in the UL subband in at least one downlink symbols; and
in response to transmitting, by the UE, the PRACH transmission in the RO within the UL subband:
the UE is determined as a UE having UL subband capability by the base station, and at least one of the following:
in response to the UE accessing a network, uplink transmission is scheduled in the UL subband,
a physical uplink shared channel (PUSCH) associated with the PRACH transmission is scheduled in the UL subband,
a physical uplink control channel (PUCCH) associated with the PRACH transmission is scheduled in the UL subband,
a hybrid automatic repeat request acknowledgement (HARQ-ACK) physical uplink control channel (PUCCH) associated with the PRACH transmission and corresponding to a physical downlink shared channel (PDSCH) reception with an UE contention resolution identity is scheduled in the UL subband, or
in response to a second PRACH transmission from a second RO being scheduled in the UL subband, the UE directly performs the second PRACH transmission without determining a validity of the second RO.

15-18. (canceled)

19. The method according to claim 1, further comprising:
based on at least one of the following: a first parameter or a second parameter in the RO configuration, determining the RO in the frequency domain within the UL subband, wherein:
the first parameter indicates an offset of a starting resource block (RB) of the RO relative to a starting RB of the UL subband, and
the second parameter indicates a number of RBs in the RO.

20. The method according to claim 1, wherein:
the UL subband is configured to be overlapping and beyond an initial UL bandwidth part (BWP) in the frequency domain;
the PRACH transmission is performed in frequency domain resources from the UL subband being overlapping the initial UL BWP; and
the PRACH transmission for a purpose other than an initial random access is performed in frequency domain resources from the UL subband beyond the initial UL BWP.

21. The method according to claim 1, wherein:
the UL subband is configured to be overlapping and within an initial UL BWP in the frequency domain; and
the PRACH transmission is performed in any frequency domain resource from the UL subband within the initial UL BWP.

22-26. (canceled)

27. A method for wireless communication, comprising:
receiving, by a base station, a physical random access channel (PRACH) transmission from a user equipment (UE) by:
configuring, by the base station, a random access channel occasion (RO) configuration for the UE;
determining, by the base station, whether the RO is valid for a UL subband based on a set of pre-defined rules, wherein the UL subband is configured in at least one downlink (DL) symbol or at least one flexible symbol and is configured within a part of frequency domain resources of the at least one DL symbol or at least one flexible symbol; and
in response to the determining that the RO is valid, receiving, by the base station, the PRACH transmission in the RO from the UE.

28. The method according to claim 27, wherein:
the set of pre-defined rules comprises that the UL subband is configured for the UE and the UE is provided with a specific information element (IE);
the determining whether the RO is valid comprises: in response to the set of pre-defined rules being satisfied, determining that the RO is valid;
the set of pre-defined rules further comprises at least one of the following:
that the RO is in the UL subband;
that the RO starts at least T symbols after a last pure downlink symbol, wherein T is an integer;
that the RO precedes a specific symbol in a PRACH slot and the RO ends at least T symbols before a first specific symbol;
that the RO is later than a specific symbol in a PRACH slot and the RO starts at least T symbols after a last specific symbol; or
that the RO starts at least T symbols after a last downlink symbol used for downlink transmission for the UE; and
the specific symbol comprises an end or a start synchronization signal (SS)/physical broadcast channel (PBCH) block symbol.

29. The method according to claim 28, wherein:
the set of pre-defined rules further comprises at least one of the following:
that the RO spans the UL subband and an uplink symbol in the time domain,
that the RO spans the UL subband and a flexible symbol in the time domain,
that the flexible symbol is not dynamically indicated for a downlink transmission,
that a timing advance (TA) of the uplink symbol and a TA of the UL subband are same,
that a timing advance (TA) of the flexible symbol and a TA of the UL subband are same,
that a timing advance offset between the symbols of the UL subband and the UL symbols is predefined as 0 or configured as 0 by the base station,
that a timing advance offset between the symbols of the UL subband and the flexible symbols is predefined as 0 or configured as 0 by the base station, or
that the RO starting from a subband full duplex (SBFD) symbol configured with the UL subband and ending in a non-SBFD symbol not configured with the UL subband is determined to be valid based on configuration signaling from the base station, wherein the same frequency resources are used for both the SBFD symbol and non-SBFD symbol of the RO, and the SBFD symbol and the non-SBFD symbol for the RO are continuous in the time domain.

30. The method according to claim 27, wherein:
the UE is configured with an UL subband;
the RO is configured in the UL subband in at least one downlink symbols; and
in response to receiving, by the base station, the PRACH transmission in the RO within the UL subband:
the base station determines the UE as a UE having UL subband capability, and at least one of the following:
in response to receiving the UE's access to a network, the base station configures uplink transmission in the UL subband,
the base station configures a physical uplink shared channel (PUSCH) associated with the PRACH transmission in the UL subband,
the base station configures a physical uplink control channel (PUCCH) associated with the PRACH transmission in the UL subband,
the base station configures a hybrid automatic repeat request acknowledgement (HARQ-ACK) physical uplink control channel (PUCCH) associated with the PRACH transmission and corresponding to a physical downlink shared channel (PDSCH) reception with an UE contention resolution identity in the UL subband, or
the base station configures a second PRACH transmission from a second RO for the UE in the UL subband, so that the UE directly performs the second PRACH transmission without determining a validity of the second RO.

31. The method according to claim 27, further comprising:
based on at least one of the following: a first parameter or a second parameter in the RO configuration, determining the RO in the frequency domain within the UL subband, wherein:
the first parameter indicates an offset of a starting resource block (RB) of the RO relative to a starting RB of the UL subband, and
the second parameter indicates a number of RBs in the RO.

32. The method according to claim 27, wherein:
the UL subband is configured to be overlapping and beyond an initial UL bandwidth part (BWP) in the frequency domain;
the PRACH transmission is performed in frequency domain resources from the UL subband being overlapping the initial UL BWP; and
the PRACH transmission for a purpose other than an initial random access is performed in frequency domain resources from the UL subband beyond the initial UL BWP.

33. The method according to claim 27, wherein:
the UL subband is configured to be overlapping and within an initial UL BWP in the frequency domain; and
the PRACH transmission is performed in any frequency domain resource from the UL subband within the initial UL BWP.

34. An apparatus comprising:
a memory storing instructions; and
at least one processor in communication with the memory, wherein, when the at least one processor executes the instructions, the at least one processor is configured to cause the apparatus to perform a physical random access channel (PRACH) transmission to a base station by:
obtaining a random access channel occasion (RO) configuration for a RO;
determining whether the RO is valid for a uplink (UL) subband based on a set of pre-defined rules, wherein the UL subband is configured in at least one downlink (DL) symbol or at least one flexible symbol and is configured within a part of frequency domain resources of the at least one DL symbol or at least one flexible symbol; and
in response to the determining that the RO is valid, transmitting the PRACH transmission in the RO to the base station.

35. The apparatus according to claim 34, wherein:
the set of pre-defined rules comprises that the UL subband is configured for the apparatus and the apparatus is provided with a specific information element (IE);
the determining whether the RO is valid comprises: in response to the set of pre-defined rules being satisfied, determining that the RO is valid;
the set of pre-defined rules further comprises at least one of the following:
that the RO is in the UL subband;
that the RO starts at least T symbols after a last pure downlink symbol, wherein T is an integer;
that the RO precedes a specific symbol in a PRACH slot and the RO ends at least T symbols before a first specific symbol;
that the RO is later than a specific symbol in a PRACH slot and the RO starts at least T symbols after a last specific symbol; or
that the RO starts at least T symbols after a last downlink symbol used for downlink transmission for the apparatus; and
the specific symbol comprises an end or a start synchronization signal (SS)/physical broadcast channel (PBCH) block symbol.

36. An apparatus comprising:
a memory storing instructions; and
at least one processor in communication with the memory, wherein, when the at least one processor executes the instructions, the at least one processor is configured to cause the apparatus to perform:
receiving a physical random access channel (PRACH) transmission from a user equipment (UE) by:
configuring a random access channel occasion (RO) configuration for the UE;
determining whether the RO is valid for a UL subband based on a set of pre-defined rules, wherein the UL subband is configured in at least one downlink (DL) symbol or at least one flexible symbol and is configured within a part of frequency domain resources of the at least one DL symbol or at least one flexible symbol; and
in response to the determining that the RO is valid, receiving the PRACH transmission in the RO from the UE.

37. The apparatus according to claim 36, wherein:
the set of pre-defined rules comprises that the UL subband is configured for the UE and the UE is provided with a specific information element (IE);
the determining whether the RO is valid comprises: in response to the set of pre-defined rules being satisfied, determining that the RO is valid;
the set of pre-defined rules further comprises at least one of the following:
that the RO is in the UL subband;
that the RO starts at least T symbols after a last pure downlink symbol, wherein T is an integer;
that the RO precedes a specific symbol in a PRACH slot and the RO ends at least T symbols before a first specific symbol;
that the RO is later than a specific symbol in a PRACH slot and the RO starts at least T symbols after a last specific symbol; or
that the RO starts at least T symbols after a last downlink symbol used for downlink transmission for the UE; and
the specific symbol comprises an end or a start synchronization signal (SS)/physical broadcast channel (PBCH) block symbol.
